(19) United States
(12) Patent Application Publication
(10) Pub. No.: US 2011/0133409 A1
(43) Pub. Date: Jun. 9, 2011

(54) ELECTRONIC DEVICE AND METHOD FOR MAKING WATERTIGHT STRUCTURE OF ELECTRONIC DEVICE

(75) Inventor: Makoto SHIBUYA, Tokyo (JP)

(73) Assignee: KABUSHIKI KAISHA TOSHIBA, Tokyo (JP)

(21) Appl. No.: 12/825,828

(22) Filed: Jun. 29, 2010

(30) Foreign Application Priority Data
Dec. 3, 2009 (JP) P2009-275193

(51) Int. Cl. F16J 15/10; F16J 15/06; B29C 39/12; B29C 39/10

(52) U.S. Cl. 277/312; 277/650; 264/250

(57) ABSTRACT

An electronic device is provided. The electronic device has a gland-side housing member formed by a hard resin. The gland-side housing member has a trench-like gland forming portion along and close to an outer fringe of the gland-side housing member. The electronic device has a gland-opposite housing member having a gland-opposite portion facing the gland forming portion. The electronic device has a packing gland component formed by a soft resin. The packing gland component has a packing gland portion formed and integrated with the gland-side housing member in the gland forming portion. The packing gland component has a gate portion formed on the inside of the packing gland portion as the soft resin flows into the gland forming portion. The packing gland component has an overflow portion formed by the soft resin which overflows the gland forming portion.

### CROSS REFERENCE TO RELATED APPLICATIONS

This application is based upon and claims the benefit of priority from the prior Japanese Patent Application No. 2009-275193 filed on Dec. 3, 2009; the entire contents of which are incorporated herein by reference.

### FIELD

The present invention relates to an electronic device provided with a waterproof function, and in particular to an electronic device provided with a waterproof function which can be easily implemented in a manufacturing process.

### BACKGROUND

An ordinary electronic device such as a mobile phone or a camera housed in a housing formed by housing members to be fitted to each other includes a packing gland made of silicon rubber inserted into a portion of one of the housing members to be fitted to the other of the housing members, and is thereby provided with a watertight structure implemented by the packing gland. There is a problem, however, in that such a structure is implemented at the cost of working to insert the packing gland into the housing and to examine the insertion. There is another problem in that waterproof performance varies depending upon how the packing gland is inserted.

It is known to implement a watertight structure, in order to deal with the problems, by shaping a packing gland for maintaining water-proofing between front and rear cases made of a hard resin integrated with the rear case by using a soft resin.

Such a watertight structure does not need an element only for making the case watertight, and can reduce the number of parts and working hours for assembly.

An electronic device such as a mobile phone or a camera, however, needs to employ multiple-point gates for inflows of soft resin for shaping a packing gland owing to the housing size. The multiple-point gates, however, can possibly cause weld lines in some cases where flows of the resin coming from different gates are merged and fused with one another.

There is a problem, as a result, in that a watertight structure provided with a packing gland having weld lines has neither a sufficient packing effect at a portion of the weld lines, nor a required waterproof effect.

Further, it can be difficult to apply some kind of soft resin material to a packing gland differently from an ordinarily used packing grand made of silicon, depending upon the packing performance based on hardness or compression permanent strain or on stickiness to a housing made of a hard resin.

### BRIEF DESCRIPTION OF THE DRAWINGS

FIG. 1 shows an external front view of a flip-type mobile phone, i.e., an exemplary electronic device of an embodiment of the present invention in an open state being open up to approximately 180 degrees.

FIG. 2 shows an external front view of the mobile phone shown in FIG. 1 in a closed state.

FIG. 3 is a disassembled perspective view of a first housing of the mobile phone of the embodiment.

FIG. 4 is a cross section of the first housing indicated by “IV-IV” in FIG. 3.

FIG. 5 is an enlarged drawing of an area “V” shown in FIG. 4.

FIG. 6 is an external perspective view of a gland-side housing member of the first housing on which a packing gland component is formed.

FIG. 7 is an enlarged drawing of an area “VII” shown in FIG. 6.

FIG. 8 is a cross section of the gland-side housing member indicated by “VIII-VIII” in FIG. 7.

FIG. 9 is a cross section of what is shown in FIG. 7 excluding the packing gland component.

FIG. 10 is a cross section of what is shown in FIG. 8 excluding the packing gland component.

FIG. 11 is a table for showing general properties of materials to be used for packing gland components.

FIG. 12 illustrates a modification of a gate cut-off portion shown in FIG. 9.

FIG. 13 is a cross section indicated by “XIII-XIII” in FIG. 12.

FIG. 14 illustrates what is shown in FIG. 12 excluding the packing gland component.

FIG. 15 is a cross section of what is shown in FIG. 13 excluding the packing gland component.

### DETAILED DESCRIPTION

An advantage of an embodiment is to provide an electronic device provided with a waterproof function which can be easily implemented in a manufacturing process.

According to an embodiment, an electronic device is provided. The electronic device has a gland-side housing member formed by a hard resin. The gland-side housing member has a trench-like gland forming portion along and close to an outer fringe of the gland-side housing member. The electronic device has a gland-opposite housing member having a gland-opposite portion facing the gland forming portion. The electronic device has a packing gland component formed by a soft resin. The packing gland component has a packing gland portion formed and integrated with the gland-side housing member in the gland forming portion. The packing gland component has a gate portion formed on the inside of the packing gland portion as the soft resin flows into the gland forming portion. The packing gland component has an overflow portion formed by the soft resin which overflows the gland forming portion.

An embodiment of the present invention will be explained with reference to the drawings. An exemplary electronic device of the embodiment is a mobile phone which will be explained.

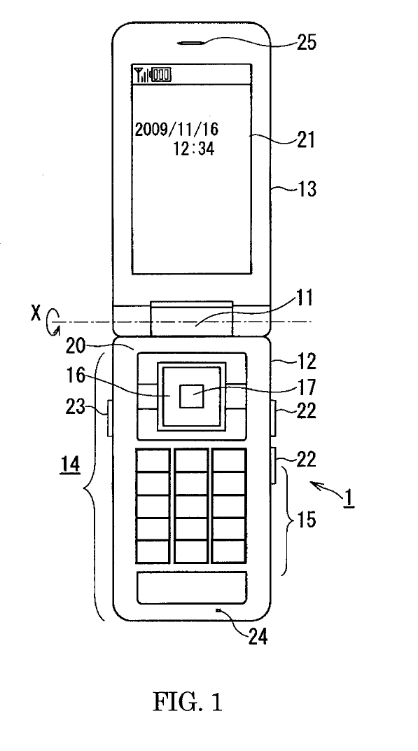

FIG. 1 shows an external front view of a flip-type mobile phone 1, i.e., an exemplary electronic device of the embodiment in an open state being open up to approximately 180 degrees.

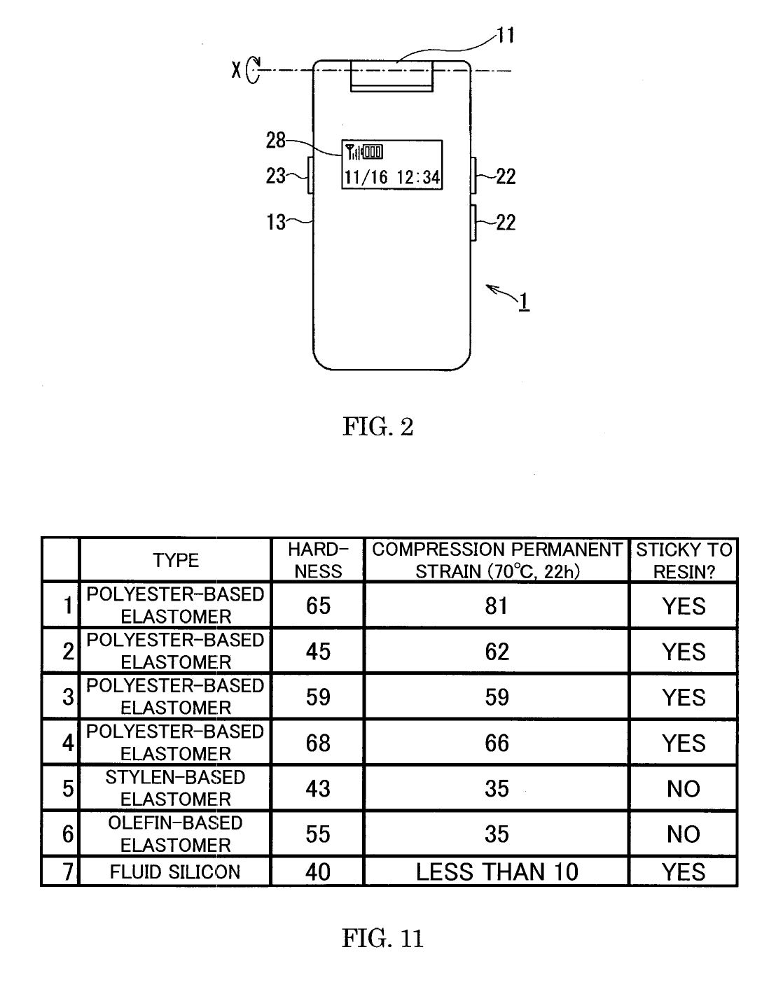

FIG. 2 shows an external front view of the mobile phone 1 shown in FIG. 1 in a closed state.

The mobile phone 1 is formed by a first housing 12 and a sec-ond housing 13 arranged on both sides of a hinge section 11 in the middle and hinge-coupled with each other. The first housing 12 and the second housing 13 are formed in such a way that the former can be flipped over on the latter around the hinge section 11 in a direction indicated by an arrow X in FIG. 1. The mobile phone 1 is provided at a certain internal position with a built-in antenna for transmitting and receiving radio waves. The mobile phone 1 transmits and receives radio waves to and from a base station (not shown) via the built-in antenna.

The first housing 12 is provided on a front face with operation keys 14. The operation keys 14 include a plurality of keys such as numeric keys 15, a 4-way scroll key 16, a selection key 17, etc.

The numeric keys 15 can be used for accepting inputs of numerals “0” to “9”, Japanese syllabic letters arranged in plural rows and alphabets “A” to “Z”. The 4-way scroll key 16 is operated up, down, leftwards and rightwards so as to accept inputs for moving a cursor, etc. displayed on a main display 21 up, down, leftwards and rightwards. Further, the selection key 17 is pressed so as to accept instructions to carry out various selection processes, etc.

The first housing 12 is provided on a side face with side keys 22. Each of the side keys 22 is pressed towards the inside of the first housing 12 while the mobile phone 1 is in the open state or in the closed state, so as to accept instructions to carry out a certain process. The first housing 12 is provided on a side face other than that provided with the side keys 22 with an external connection terminal 23 to be connected with an external device. The external connection terminal 23 is, e.g., a power supply terminal for charging a battery of the mobile phone 1 or a USB terminal.

The first housing 12 is provided with a microphone 24 below the operation keys 14. The mobile phone 1 collects voice of a user by means of the microphone 24 while the user is speaking by using the mobile phone 1.

Incidentally, the mobile phone 1 is provided on a back with a battery holding aperture (not shown) to be loaded with a battery pack.

Meanwhile, the second housing 13 is provided with the main display 21 which occupies most of the area of the second housing 13. The main display 21 can display email content and simplified Web pages as well as indicators for indicating received radio wave condition and remaining battery power, and the present date and time. Incidentally, the main display 21 is constituted, e.g., by an LCD (Liquid Crystal Display), an organic electroluminescence display or an inorganic electroluminescence display.

The second housing 13 is provided with a receiver (earpiece) 25 at a certain position above the main display 21. The mobile phone 1 produces voice of someone who is calling via the receiver 25. The user can conduct voice communication by using the receiver 25 and the microphone 24.

As shown in FIG. 2, the second housing 13 is provided with a sub-display 28 constituted, e.g., by an LCD. The sub-display 28 displays indicators for indicating received radio wave condition and remaining battery power, and the present date and time.

Then, a watertight structure of the first housing 12 will be explained as an exemplary watertight structure of the mobile phone 1 of the embodiment. Incidentally, although the watertight structure of the first housing 12 will be explained in particular, the second housing 13 can also be provided with a similar watertight structure.

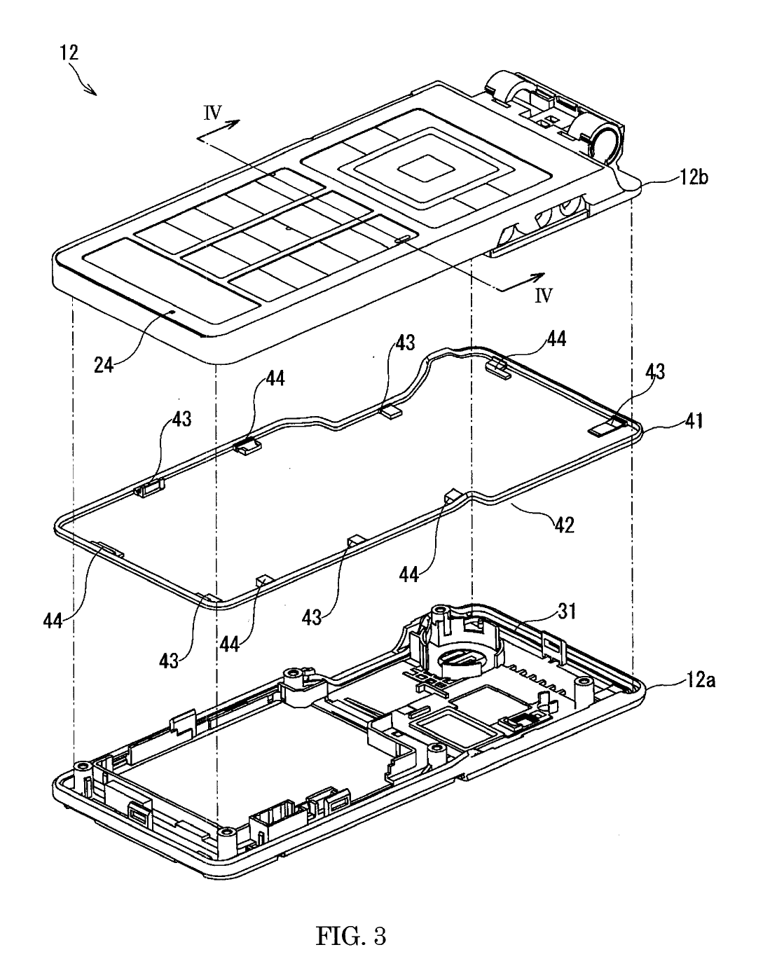

FIG. 3 is a disassembled perspective view of the first housing 12 of the mobile phone 1 of the embodiment.

FIG. 4 is a cross section of the first housing 12 indicated by “IV-IV” in FIG. 3.

FIG. 5 is an enlarged drawing of an area “V” shown in FIG. 4.

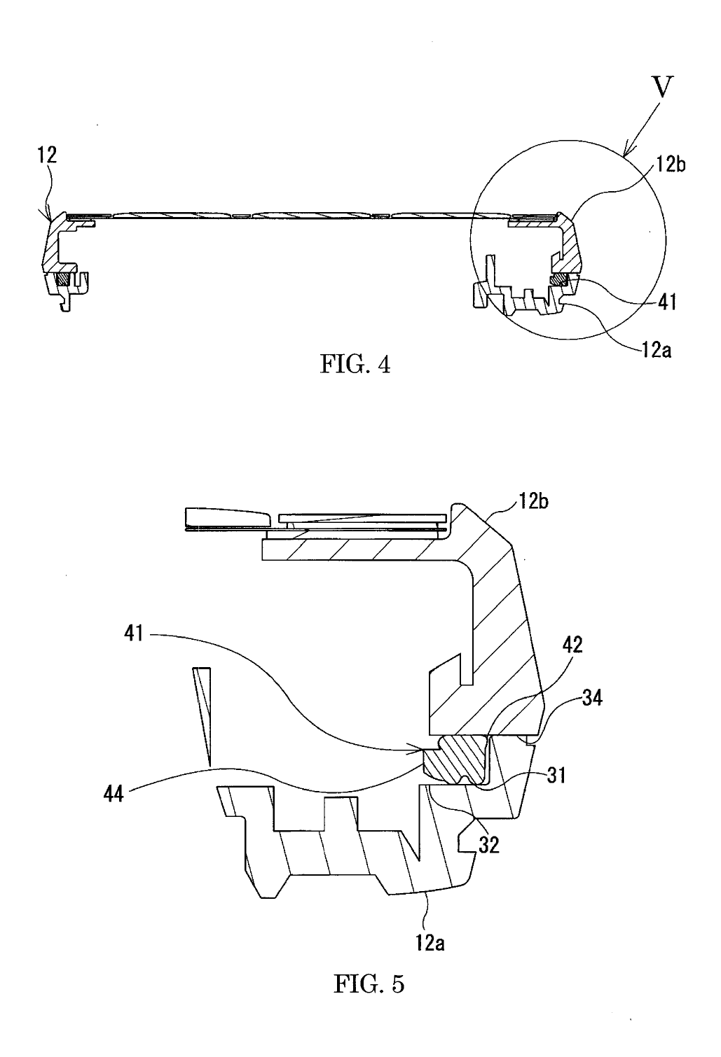

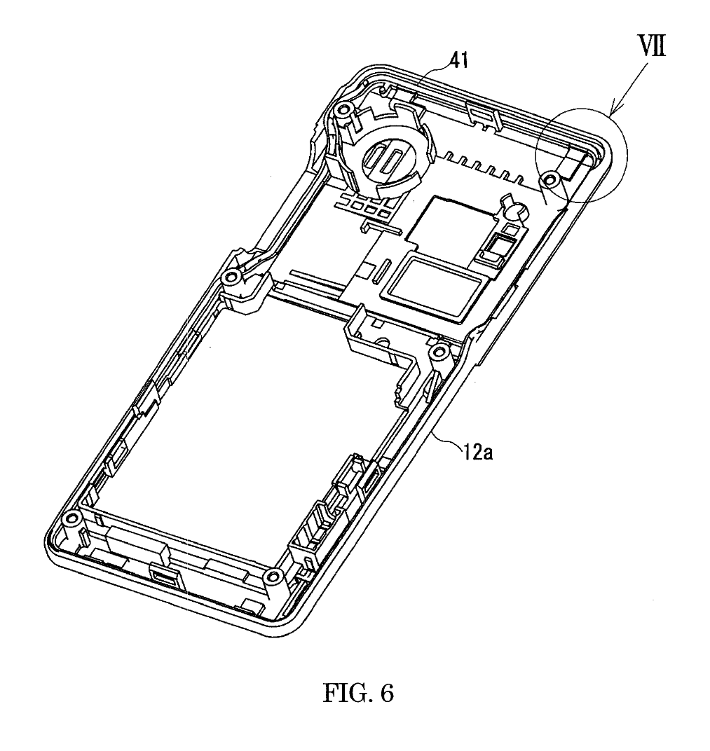

FIG. 6 is an external perspective view of a gland-side housing member 12a of the first housing 12 on which a packing gland component 41 is formed.

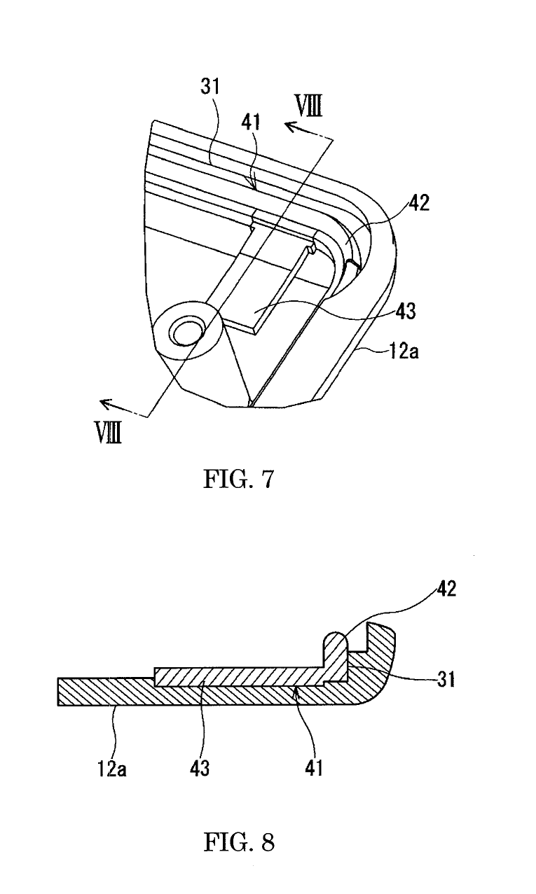

FIG. 7 is an enlarged drawing of an area “VII” shown in FIG. 6.

FIG. 8 is a cross section of the gland-side housing member 12a indicated by “VIII-VIII” in FIG. 7.

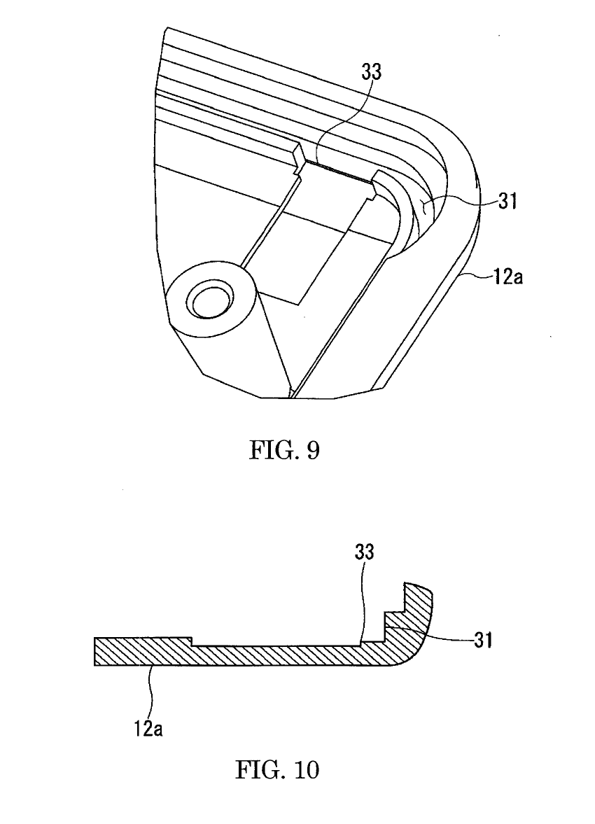

FIG. 9 is a cross section of what is shown in FIG. 7 excluding the packing gland component 41.

FIG. 10 is a cross section of what is shown in FIG. 8 excluding the packing gland component 41.

As shown in FIG. 3, the first housing 12 has portions for implementing the watertight structure of the mobile phone 1 which are the gland-side housing member 12a, a gland-opposite housing member 12b and the packing gland component 41. Incidentally, other internal portions of the mobile phone 1 contained in the first housing 12 are neither explained nor shown in the drawings for convenience of explanation.

The gland-side housing member 12a has a trench-like gland forming portion 31 along and close to an outer fringe. The gland forming portion 31 has an overflow cut-off portion 32 where a portion of the trench wall is cut off so that an overflow portion 44 of the packing gland component 41 is formed towards the inside of the gland-side housing member 12a (refer to FIG. 5). Further, the gland forming portion 31 has a gate cut-off portion 33 where a portion of the trench wall is cut off so that a gate portion 43 of the packing gland component 41 is formed towards the inside of the gland-side housing member 12a (refer to FIGS. 7-10). The gate cut-off portion 33 and the overflow cut-off portion 32 are provided at specific portions in accordance with the numbers of gates and overflows in case of insert molding or two-color molding.

The gland-opposite housing member 12b is combined with the gland-side housing member 12a so as to form an external appearance of the first housing 12. The gland-opposite housing member 12b has a gland-opposite portion 34 which faces the gland forming portion 31 of the gland-side housing member 12a when the first housing 12 is assembled (refer to FIG. 5). The gland-opposite portion 34 is provided substantially along an outer fringe of the gland-side housing member 12a. The gland-opposite portion 34 has a certain width so as to compress a packing gland portion 42 formed on the gland forming portion 31 towards the gland-side housing member 12a.

The packing gland component 41 is formed and integrated with the gland forming portion 31 of the gland-side housing member 12a by means of insert molding or two-color molding (called “insert molding, etc.” hereafter). The packing gland component 41 has the packing gland portion 42, the gate portion 43 and the overflow portion 44.

The packing gland portion 42 is partially contained in the trench of the gland forming portion 31 and is formed to bulge above the upper fringe of the trench (refer to FIG. 8). The packing gland portion 42 is compressed by the above described gland-opposite portion 34 of the gland-opposite housing member 12b so as to form a watertight structure.

The gate portion 43 is formed on the inside of the packing gland portion 42, as shown in FIG. 3, if soft resin material flows from a gate formed in a mold towards the gland forming portion 31 in case of insert molding, etc. The overflow portion 44 is formed on the inside of the packing gland portion 42 by the soft resin material which overflows from the gland forming portion 31 towards an overflow portion formed in the mold in case of insert molding, etc. A plurality of the gate portions 43 is provided at proper positions in accordance with the shape and size of the gland-side housing member 12a. Further, each of the overflow portions 44 is provided between the adjacent gate portions 43.

The gland-side housing member 12a and the gland-opposite housing member 12b are molded out of hard resin materials such as an ABS resin or a polycarbonate resin. The gland forming portion 31, the gate cut-off portion 33 and the overflow cut-off portion 32 of the gland-side housing member 12a and the gland-opposite portion 34 of the gland-opposite housing member 12b are properly shaped when individually being molded.

As described above, the packing gland component 41 is molded into the gland forming portion 31 of the gland-side housing member 12a out of soft resin materials such as a polyester-based elastomer, a styrene-based elastomer or an olefin-based elastomer by means of an insert or two-color molding process. The packing gland component 41 is formed by a soft resin material injected from a gate provided in a mold. The soft resin material injected from the gate passes the gate cut-off portion 33 of the gland-side housing member 12a, flows into the trench-like gland forming portion 31, and then forms the packing gland portion 42 after being cooled. The soft resin material cooled on the gate forms the gate portion 43 from the gate cut-off portion 33 to the inside of the packing gland portion 42.

Meanwhile, a portion of the soft resin material injected into the gland forming portion 31 passes the overflow cut-off portion 32 and overflows in accordance with the shape of the mold. The soft resin material having overflowed and cooled forms the overflow portion 44 over the overflow cut-off portion 32 to the inside of the packing gland portion 42.

The watertight structure of the mobile phone 1 is implemented, as described above, by the packing gland component 41 formed and integrated with the gland-side housing member 12a by means of the insert molding process, etc. As there is no need to fit the packing gland component 41 into the gland-side housing member 12a or to test the gland-side housing member 12a that the packing gland component 41 is fit into, working and testing costs can be reduced.

As the packing gland component 41 can be formed and integrated with the gland-side housing member 12a by means of the insert molding or two-color molding process, performance of the packing gland can be prevented from varying owing to variations of the shape of the packing gland component 41 or of the fitting work.

As the packing gland component 41 is formed and integrated with the gland-side housing member 12a, there is no need to think of handling for the fitting work, and the width of the packing gland portion 42 can be reduced to a minimum which satisfies the performance of the packing gland. As a result, the mobile phone 1 itself can be downsized.

Moreover, the overflow portions are provided so that weld lines can be prevented from being caused by the multiple-point gates, and that a problem in an unsatisfactory waterproof function caused by the weld lines can be dealt with.

Then, the soft resin material to be used for the packing gland component 41 will be explained.

FIG. 11 is a table for generally showing properties of materials to be used for packing gland components.

For soft resin materials, e.g., a polyester-based elastomer, a styrene-based elastomer, an olefin-based elastomer or a liquid silicon are used. One of those materials having low hardness, low compression permanent strain and having stickiness to the hard resin used as the material of the gland-side housing member 12a is fit for the packing gland component 41. A reason why is that the material having the low hardness property causes small rebounding force so that the material has great room for squashing and can easily absorb variations of fitting work, and that the material has good tracking property. The material having the low compression permanent strain property can recover well upon being squashed and shows good packing capability. The material having the property of stickiness to the hard resin hardly puts out of the gland-side housing member 12a and thereby excels in workability and productivity. Further, as forming time and cost for forming an elastomer can be reduced, it is advantageous in that a manufacturing unit price can be reduced.

In consideration of the above, it can be said that the hardness and the compression permanent strain values of the styrene- and olefin-based elastomers are smaller than those of the polyester-based elastomer, and that the styrene- and olefin-based elastomers excel in packing capability. The styrene- and olefin-based elastomers, how-ever, lack the property of stickiness to the hard resin, and have a shortcoming of poor workability and productivity.

Even if the styrene- and olefin-based elastomers are used as the material of the packing gland component 41, however, the gland-side housing member 12a can physically hold the packing gland component 41 in a structure explained below.

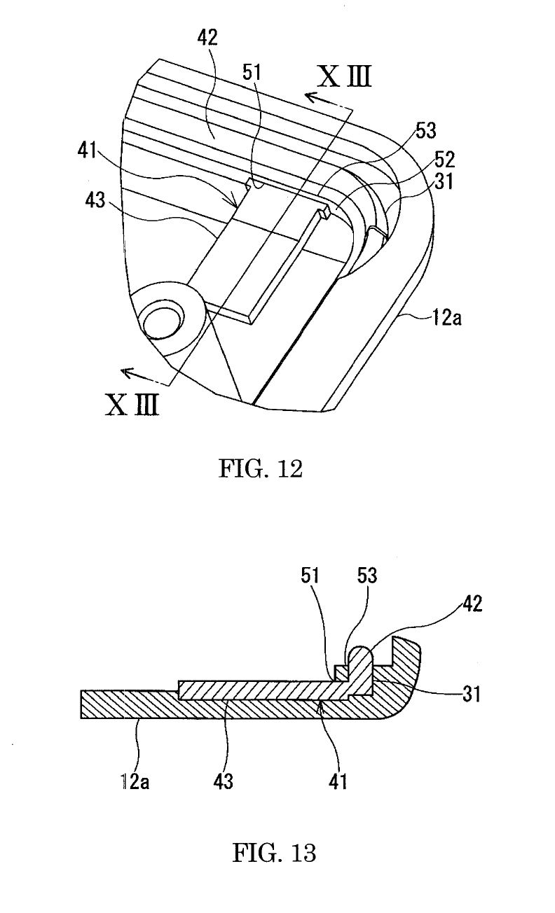

FIG. 12 illustrates a modification of the gate cut-off portion shown in FIG. 9.

FIG. 13 is a cross section shown by “XIII-XIII” in FIG. 12.

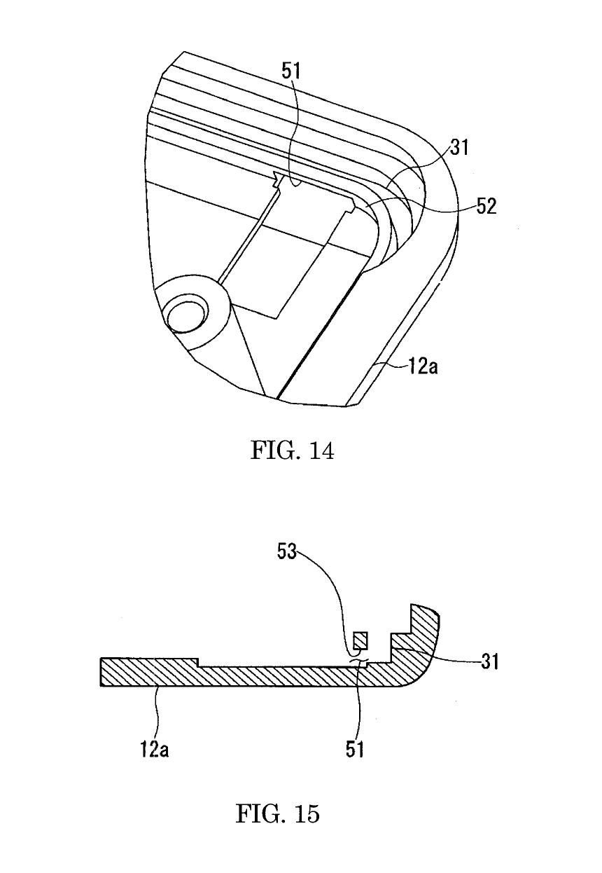

FIG. 14 illustrates what is shown in FIG. 12 excluding the packing gland component 41.

FIG. 15 is a cross section of what is shown in FIG. 13 excluding the packing gland component 41.

In order that the gland-side housing member 12a can physically hold the packing gland component 41, the gland forming portion 31 of the gland-side housing member 12a is provided with a gate portion engaging hole 51 and an overflow portion engaging hole which function to prevent the gate portion 43 and the overflow portion 44, respectively, from being put out of the gland forming portion 31. Incidentally, only the gate portion engaging hole 51 is shown in FIGS. 12-15, and the overflow portion engaging hole is similarly formed and its explanation referring to the drawings is omitted.

The gate portion engaging hole 51 and the overflow portion engaging hole are openings formed on a trench wall 52 on the inside of the gland forming portion 52. The gate portion engaging hole 51 and the overflow portion engaging hole are formed together with the gland forming portion 31, etc. when the gland-side housing member 12a is formed.

The gate portion engaging hole 51 is a portion through which a soft resin material injected from a gate provided to a mold passes and flows into the gland forming portion 31 in case of insert molding, etc. The overflow portion engaging hole is a portion through which the soft resin which has flowed into the gland forming portion 31 partially passes and overflows the gland forming portion 31.

The soft resin injected from the gate and passing the gate portion engaging hole 51 and the overflow portion engaging hole is cooled after being formed and forms the gate portion 43 and the overflow portion 44, respectively. That is, the gate portion 43 and the overflow portion 44 are formed on the inside of the packing gland portion 42 in a state in which they pass and are engaged with the gate portion 43 and the overflow portion 44, respectively.

As a result, even if the packing gland component 41 is possibly put out of the gland-side housing member 12a, the gate portion 43 and the overflow portion 44 are physically pressed by upper sides 53 (refer to FIG. 15) of the gate portion engaging hole 51 and the overflow portion, respectively, in the structure of the packing gland component 41. The gate portion engaging hole 51 and the overflow portion engaging hole can function to prevent the packing gland component 41 from being put out owing to the structure. Thus, the styrene- or olefin-based elastomers lacking the property of stickiness to hard resin materials can prevent being put out of the gland forming portion 31, so as to be handled similarly as the polyester-based elastomer having the property of stickiness.

Incidentally, there is no need to provide every one of the gate portions 43 and the overflow portions 44 with the gate portion engaging hole 51 and the overflow portion engaging hole, respectively. Further, it is allowable to provide only the gate portion engaging holes 51 or only the overflow portion engaging holes.

The electronic device of the present invention is applied to the mobile phone 1, as explained above, and can be applied to a PDA (Personal Digital Assistant), a personal computer, a portable game machine, a portable music player, a portable movie player and another electronic device.

What is claimed is:

1. An electronic device comprising:
a gland-side housing member formed by a hard resin, the gland-side housing member having a trench-like gland forming portion along and close to an outer fringe of the gland-side housing member;
a gland-opposite housing member having a gland-opposite portion facing the gland forming portion; and
a packing gland component formed by a soft resin, the packing gland component having a packing gland portion formed and integrated with the gland-side housing member in the gland forming portion, the packing gland component having a gate portion formed on the inside of the packing gland portion as the soft resin flows into the gland forming portion, the packing gland component having an overflow portion formed by the soft resin which overflows the gland forming portion.

2. The electronic device according to claim 1, wherein the packing gland component forms a watertight structure as the packing gland portion is compressed by the gland-opposite portion.

3. The electronic device according to claim 1, wherein the packing gland portion is formed by means of an insert molding process or a two-color molding process.

4. The electronic device according to claim 1, wherein the gland forming portion has a gate portion engaging hole formed on a trench wall of the gland forming portion, the gate portion engaging hole engaging the gate portion formed after the soft resin flows into the gland forming portion when the packing gland portion is formed, the gland forming portion has an overflow portion engaging hole engaging the overflow portion formed after the soft resin overflows when the packing gland portion is formed.

5. The electronic device according to claim 1, wherein the soft resin is a styrene-based elastomer or an olefin-based elastomer.

6. A method for making a watertight structure of an electronic device, comprising:
forming a gland-side housing member by using a hard resin;
providing the gland-side housing member with a trench-like gland forming portion along and close to an outer fringe of the gland-side housing member;
forming a gland-opposite housing member having a gland-opposite portion facing the gland forming portion;
forming a packing gland component by using a soft resin;
forming a packing gland portion of the packing gland component which is integrated with the gland-side housing member in the gland forming portion;
forming a gate portion of the packing gland component on the inside of the packing gland portion as the soft resin flows into the gland forming portion; and
forming an overflow portion of the packing gland component by using the soft resin which overflows the gland forming portion.

7. The method for making a watertight structure of an electronic device according to claim 6, wherein the packing gland component forms a watertight structure as the packing gland portion is compressed by the gland-opposite portion.

8. The method for making a watertight structure of an electronic device according to claim 6, wherein the packing gland portion is formed by means of an insert molding process or a two-color molding process.

9. The method for making a watertight structure of an electronic device according to claim 6, further comprising:
forming a gate portion engaging hole on a trench wall of the gland forming portion, the gate portion engaging hole engaging the gate portion formed after the soft resin flows into the gland forming portion when the packing gland portion is formed; and
forming an overflow portion engaging hole after the soft resin overflows when the packing gland portion is formed, the overflow portion engaging hole engaging the overflow portion.

10. The method for making a watertight structure of an electronic device according to claim 6, wherein the soft resin is a styrene-based elastomer or an olefin-based elastomer.
